(19) United States
(12) Patent Application Publication
(10) Pub. No.: US 2014/0068042 A1
(43) Pub. Date: Mar. 6, 2014

(54) Method and Apparatus for Accelerated Virtual Image Provisioning in Distributed Cloud Environments

(71) Applicants: Ashish Mungi, Bangalore (IN); Kapuveera R. Reedy, Bangalore (IN); Ram Viswanathan, (US); Navjot S. Bhogal, Bangalore (IN); Bhupesh Gupta, Bangalore (IN); Manjit Singh Sodhi, Bangalore (IN)

(72) Inventors: Ashish Mungi, Bangalore (IN); Kapuveera R. Reedy, Bangalore (IN); Ram Viswanathan, (US); Navjot S. Bhogal, Bangalore (IN); Bhupesh Gupta, Bangalore (IN); Manjit Singh Sodhi, Bangalore (IN)

(73) Assignee: INTERNATIONAL BUSINESS MACHINES CORPORATION, Armonk, NY (US)

(21) Appl. No.: 13/605,196

(22) Filed: Sep. 6, 2012

(51) Int. Cl. G06F 15/173

(52) U.S. Cl. 709/223

(57) ABSTRACT

Systems, methods and/or software where a separate image repository server (IRS) is created and maintained in each and every network and/or subnet segment that includes a destination server associated with the managed pool. Also, when a given virtual image is provisioned to a given destination server then the present invention preferably ensures that the IRS used as a source of the given virtual image is an IRS located in the same subnet and same network as the given destination server.

### BACKGROUND OF THE INVENTION

1. Field of the Invention

The present invention relates to virtual image provisioning in distributed cloud environments, networks having multiple subnets and/or environments including multiple networks.

2. Description of the Related Art

Cloud management environments (CME) are known. One example of this is called the IBM Tivoli Service Automation Manager (TSAM). TSAM enables users to request, deploy, monitor and manage cloud computing services. It also provides traceable approvals and processes. The main use of TSAM is to automate technical as well as business processes involved in deploying new IT services. For example, TSAM can perform intermediate processing between: (i) a user with a service request, and (ii) a hypervisor that manages some hardware resource pool on which the service associated with the user's service request will be run. TSAM maintains a large collection of objects and their attributes, which forms its Data Center Model that is stored in a separate database.

One function provided by a CME (like TSAM) is the provisioning of virtual images. The virtual image is generally an image of software and/or data as it is installed and configured on an actual machine. For example, an installed operating system (OS), a set of installed and configured application programs (for running on the OS) and associated data may be put into a virtual image. By using the virtual image, the OS and its application and data do not need to be reinstalled and/or reconfigured when a user changes machines, or when one user wants to make sure it is known exactly what another user has on her machine and how it is set up. As is well understood in the art, this minimizes installation and system configuration time spent by information technology (IT) personnel and also minimizes the risk of errors or miscommunications between users and/or IT personnel. By “provisioning” virtual images, the virtual image is communicated from one location (for example, a database of virtual images) to another location (for example, a user's computer that is planned to be operated according to the virtual image). This operation of communicating the virtual image from one location to another is called the provisioning of the virtual image.

It is known that virtual images can be accessed and provisioned in a CME. Cloud computing is the delivery of computing and/or storage capacity as a service to a heterogeneous community of end-recipients. The name comes from the use of a cloud-shaped symbol as an abstraction for the complex infrastructure it contains in associated system diagrams. Cloud computing entrusts services with a user's data, software and computation over a network, over networks including multiple subnets and/or over multiple networks.

This provisioning of virtual images in a cloud environment may be facilitated and/or enabled by a cloud management environment, like TSAM. Furthermore, once a virtual image is provisioned and run (or instantiated), it is called a virtual instance. The cloud management environment software may manage virtual instances. For example, in the cloud, an end user may be using, through the cloud, a virtual image that is remote from her own machine. This cloud networked use of virtual instances requires management, of course, and the cloud management environment software should preferably provide all necessary and/or desirable management type processing associated with provisioning virtual images and running virtual instances. The set of virtual instances managed by cloud management environment software is referred to as a “managed pool.”

It is known and recognized in the relevant art that the faster a virtual image can be provisioned: (i) the better it is for cloud service providers and consumers since reducing the time taken to provision virtual images has a positive impact on associated turnaround times and service level agreements for platform as a service (PaaS) and software as a service(SaaS); (ii) management of managed pool is thereby improved; (iii) experience of IT personnel and/or end users is improved; and/or (iv) latency, glitches, errors and the like can be reduced.

### BRIEF SUMMARY OF THE INVENTION

The speed of provisioning virtual images is described in the present invention by the acronym TTPVI, which stands for “time taken to provision virtual images.” The present invention recognizes that virtual image provisioning generally takes longer (that is, TTPVI is increased) when one or more of the following conditions hold: (i) the cloud management software is on a different network subnet segment than the managed environment and/or managed pool; and/or (ii) the cloud management software is on a different network than the managed environment and/or managed pool. For purposes of this document: (i) the term “different subnets” will refer to different network subnets (as conventionally understood) and/or different networks altogether; and (ii) the term “same subnet” will similarly refer to same subnet and same network. The present invention further recognizes that it would be desirable to reduce TTPVI specifically under conditions where different managed pools of destination server(s) are distributed among different subnets such that all destination servers managed by the CME software are not in direct communication with the same subnet.

The present invention generally relates to systems, methods and/or software (stored on a “software storage device,” see DEFINITIONS section for more information on the meaning of that term) where a separate image repository server (IRS) is created and maintained in each and every network and/or subnet segment that includes a destination server associated with the managed pool. Also, when a given virtual image is provisioned to a given destination server then the present invention preferably ensures that the IRS used as a source of the given virtual image is an IRS located in the same subnet and same network as the given destination server.

Various embodiments of the present invention may exhibit one or more of the following objects, features and/or advantages:

(i) existing CME-related software products can easily be reconfigured to practice the methods of the present invention;

(ii) decrease in TTPVI and corresponding decrease in above-noted problems (for example, latency-related problems) occasioned by relatively larger TTPVIs'

(iii) positive impact on turnaround times and service level agreements associated with provisioning of new virtual images in cloud environments;

(iv) potentially useful in platform-as-a-service (PaaS), software-as-a-service (SaaS) and/or other types of cloud environments; and/or

(v) can work in public/private/hybrid clouds (assuming, of course, appropriate communications are enabled and appropriate privileges and permissions are granted to the various system components).

According to an aspect of the present invention, managing a cloud managed environment is accomplished by a method. The method includes the following steps (not necessarily in the following order): (a) running CME software comprising a provisioning manager module and stored on a software storage device, with the CME software being in data communication with a plurality of different subnets and with each subnet having a location associated therewith and a set of destination server(s) located at the location of each subnet, with each destination server of each set of server(s) being at least partially under control of the CME software through each destination server's respectively co-located subnet; (b) establishing and maintaining a base IRS at a first location, under control of the CME software, with the base IRS including a plurality of virtual images, with the plurality of virtual images of the base IRS including all virtual images that may be provisioned by the provisioning manager module to the various destination servers; and (c) establishing and maintaining a plurality of secondary IRSs so that each subnet of the plurality of different subnets will have co-located with it at least one of the following: (i) the base IRS; or (ii) at least one secondary IRS of the plurality of secondary IRSs. Each secondary IRS of the plurality of secondary IRSs includes at least some of the virtual images of the base IRS.

According to a further aspect of the present invention, a computer system is programmed with CME software. The computer system is for use with a cloud management environment including a plurality of different subnets. Each subnet of the plurality of different subnets is respectively in direct and co-local data communication with a managed pool. Each managed pool includes a set of destination server(s). The computer system includes a set of CME computer(s). The set of CME computer(s) include a CME module in data communication with each subnet of the plurality of different subnets. The CME module includes a provisioning manager sub-module. The provisioning manager sub-module includes: a pool determination sub-sub-module, an IRS creation sub-sub-module, and an IRS configuration and control sub-sub-module. The pool determination sub-sub-module is structured, programmed and/or connected in data communication to determine the plurality of managed pools that are present in the cloud managed environment for virtual image provisioning purposes and to further determine whether each managed pool of the plurality of managed pools has an IRS co-located in direct data communication at the associated subnet of that managed pool. The IRS creation sub-sub-module is structured, programmed and/or connected in data communication to create an co-located IRS for every managed pool that is determined to lack a co-located IRS by the pool determination sub-sub-module. The IRS configuration and control sub-sub-module is structured, programmed and/or connected in data communication to control the provisioning of virtual images in the cloud managed environment so that when a first virtual image is provisioned to a first destination server on a corresponding co-located subnet, a selected IRS is selected by the IRS configuration and control module to provision the first virtual image to the first destination server so that the selected IRS is on the same subnet as the first destination server.

According to a further aspect of the present invention, a CME software is stored on a software storage device. The CME software is for use with a cloud management environment including a plurality of different subnets. Each subnet of the plurality of different subnets is respectively in direct and co-local data communication with a managed pool. Each managed pool includes a set of destination server(s). The CME software is in data communication with each subnet of the plurality of different subnets. The CME software includes a provisioning manager module which includes: a pool determination sub-module; an IRS creation sub-module; and an IRS configuration and control sub-module. The pool determination sub-module is structured, programmed and/or connected in data communication to determine the plurality of managed pools that are present in the cloud managed environment for virtual image provisioning purposes and to further determine whether each managed pool of the plurality of managed pools has an IRS co-located in direct data communication at the associated subnet of that managed pool. The IRS creation sub-module is structured, programmed and/or connected in data communication to create an co-located IRS for every managed pool that is determined to lack a co-located IRS by the pool determination sub-module. The IRS configuration and control sub-module is structured, programmed and/or connected in data communication to control the provisioning of virtual images in the cloud managed environment so that when a first virtual image is provisioned to a first destination server on a corresponding co-located subnet, a selected IRS is selected by the IRS configuration and control module to provision the first virtual image to the first destination server so that the selected IRS is on the same subnet as the first destination server.

### BRIEF DESCRIPTION OF THE DRAWINGS

FIG. 1 is a schematic view of a first embodiment of a CME system according to the present invention;

FIG. 2 is a schematic view of a portion of the first embodiment CME system;

FIG. 3 is a flowchart showing a first embodiment of a method according to the present invention;

FIG. 4 is a flowchart showing a second embodiment of a method according to the present invention;

FIG. 5 is a flowchart showing a third embodiment of a method according to the present invention; and

FIG. 6 is a schematic view of a second embodiment of a CME system according to the present invention.

### DETAILED DESCRIPTION OF THE INVENTION

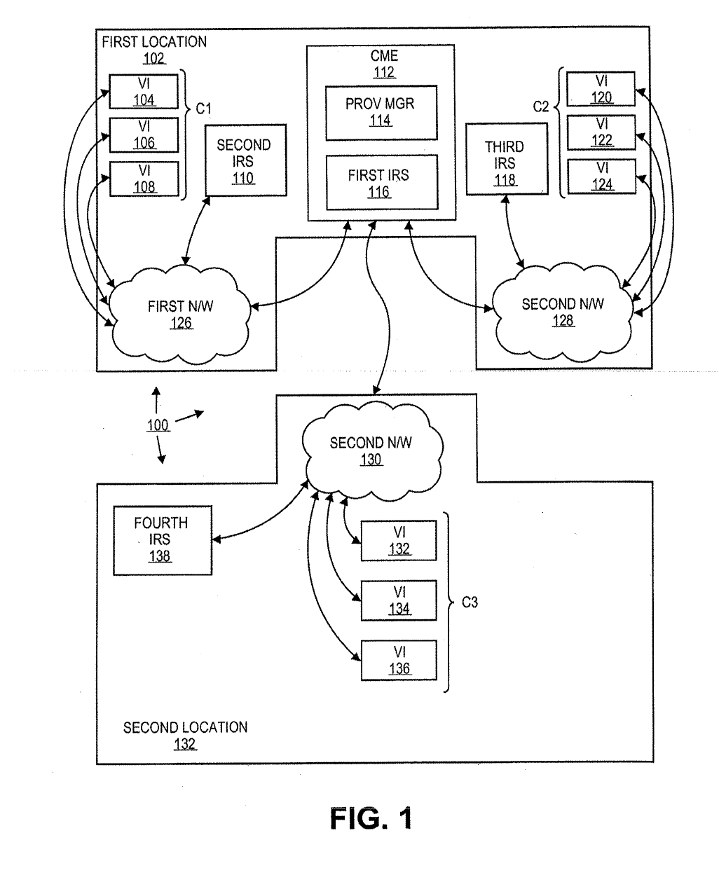

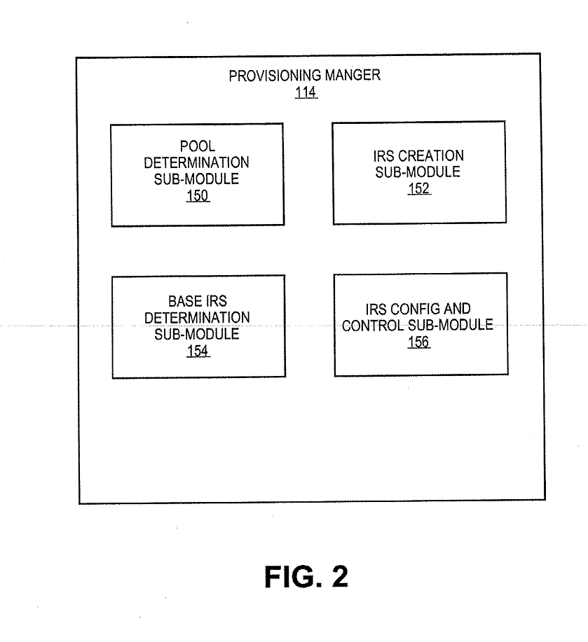

FIGS. 1 and 2 shows CME system 100, including: first location 102; and second location 132. Locations 102 and 132 are physically and geographically separate.

First location 102 includes six virtual instances (VIs) 104, 106, 108, 120, 122, 124; second image repository server (IRS) 110; cloud management software module 112 (which is stored on a software storage device (not separately shown)); third IRS 118; first network 126; and second network 128. It is noted that the first and second networks 126, 128 may not be entirely located in close physical proximity to the rest of the components that define the first location, but they are considered to be associated with the first location in a sense such that one of ordinary skill in the relevant art would consider the first and second networks to be at the first location. CME 112 includes a provisioning manager module 114; and first IRS 116 (also sometimes called the “base IRS” (see DEFINITIONS section)). Second location 132 includes third network 130; three VIs 132, 134, 136; and fourth IRS 138.

The three networks in the system 126, 128, 130 can be considered as different “subnets” and may have differing network configurations. Therefore, when this document uses the term “different subnets” it may mean either of the following: (i) different networks; and/or (ii) different subnet segments of a single network.

As shown in FIG. 2, provisioning manager module 114 includes: pool determination sub-module 150; IRS creation sub-module 152; base IRS determination sub-module 154; and IRS configuration and control sub-module 156.

In operation, provisioning manager 114 controls all of the IRSs, including first IRS 116, second IRS 110, third IRS 118 and fourth IRS 138. More specifically, in this embodiment, this control by the provisioning manager is performed: (i) for first IRS 116, directly through a computer on which CME 112 reside; (ii) for second IRS 110, through first network 126; (iii) for third IRS 118, through second network 128; and (iv) for fourth IRS 138, through third network 130.

As shown in FIG. 1, VIs 104, 106, 108 make up first managed pool C1. These VIs may be running on separate destination servers (not separately shown) or on the same destination server machine. However, as shown in FIG. 1, all three VIs 104, 106, 108 communicate through first network 126. This means that managed pool C1 is on first network 126 and located at first location 102. Similarly: (i) second managed pool C2 is on the second network at the first location; (ii) third managed pool C3 is on the third network at the second location.

The virtual instances (and/or virtual instances that may be added to this C1 managed pool over time) will periodically require the provisioning of virtual images (not separately shown) from one of the IRSs. According to the present invention, a virtual instance in a given managed pool will always have (or at least be able to have) its virtual image provisioned form an IRS on the same network (and subnet segment, where applicable) as the VI that is getting the provisioned virtual image. This system architecture decreases TTPVI, which is a good thing, as explained above. As can be seen from FIG. 1, this kind of advantageous provisioning applies to first pool C1, second pool C2 and third pool C3. If additional networks and associated managed pools are added to the system over time, these new managed pools can also be supplied with IRSs, thereby keeping TTPVI to a minimum across the growing system as a whole.

When a new provisioning request is received for a specific managed pool (C1, C2 or C3), the provisioning manager instantiates a base virtual image from the appropriate IRS to a destination server (not separately shown) within that specific managed pool. The provisioning manager subsequently performs other operations to complete the virtual image provisioning (as will be understood by those of skill in the art) to complete the virtual image provisioning on the requesting managed pool. This image provisioning will be based in part on request parameters (again, as will be understood by those of skill in the art). In this way, when getting a new virtual image provisioned, the managed pool references the appropriate IRS (that is, the one in the same subnet) and instantiates the appropriate virtual image from that appropriate IRS.

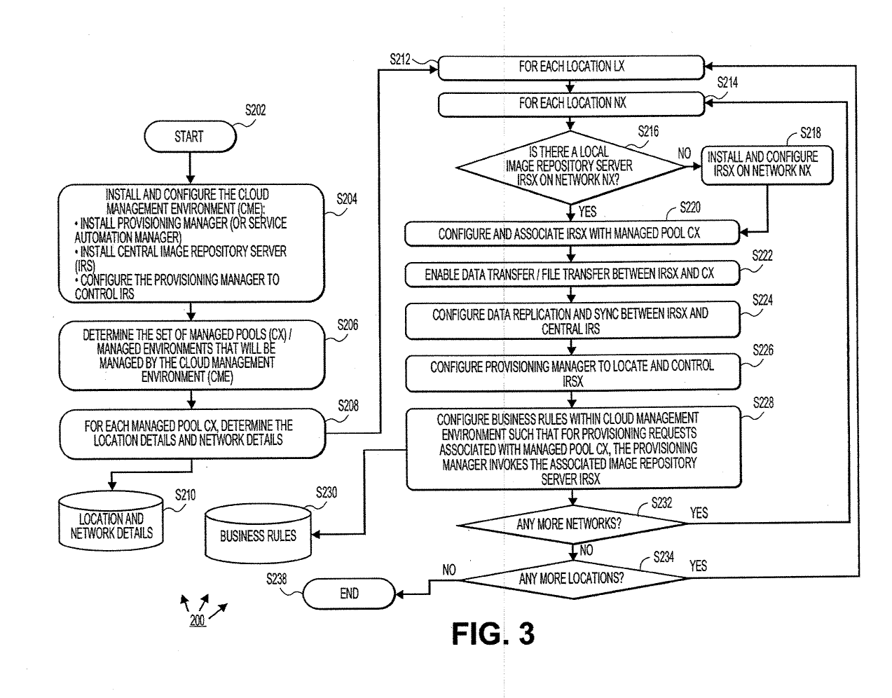

As shown in FIG. 1, first IRS 116 serves as a base image repository of virtual images used within the CME system, and, in this embodiment it is considered as a “central IRS” because it is a base IRS located within the CME software itself. Alternatively, first IRS could be omitted, and one of the other IRSs 110, 118, 138 could be used as the base image repository. As will be discussed in detail below in connection with FIG. 2 and the flowcharts of FIGS. 3, 4 and 5, the provisioning manager controls the creation and maintenance of all the IRSs system-wide. The provisioning manager is configured to be “aware” of all the IRSs system-wide so that it can control and maintain all of them. Appropriate business rules can also be configured.

While each managed pool C1, C2, C3 is shown with three VIs, it should be understood that each managed pool may have more, or fewer, VIs, and more, or fewer, destination server machines (not separately shown). There is not necessarily a one-to-one correspondence between VIs and destination server machines.

Data sync, replication and file transfer occur between the base IRS 116 and the other IRSs 110, 118, 138 respectively through the three communication networks. The data sync should insure that all virtual images necessary for the operation of a given pool C1, C2, C3 are present in the respectively associated IRS 110, 118, 138. In other words, each IRS may be tailored to include only the virtual images it needs to serve the needs of its pool, or, alternatively, each IRS could contain all the virtual images on a system-wide basis.

As shown in FIG. 2, pool determination sub-module determines how many managed pools are present system-wide and whether each pool has an IRS on its associated subnet. If a managed pool lacks an IRS on its sub-net, then an appropriate IRS may be created on that subnet by IRS creation sub-module 152.

Base IRS (see DEFINITIONS section) determination module 154 determines and controls the central IRS or primary IRS, which includes all virtual images on a system-wide basis. As explained above, the base IRS may or may not be included in CME 112 itself. As mentioned above and in the DEFINITIONS section, if the base IRS is included in the CME software then it is herein called a “central IRS;” and if the base IRS is not included in the CME software then it is herein called a “primary IRS.”

IRS configuration and control sub-module 156 configures and controls the IRSs other than the base IRS, as will be further discussed in connection with the flowcharts of FIGS. 3, 4 and 5.

FIG. 3 shows process flow 200 associated with systems where there is an IRS resident in the CME software itself. These type of embodiments are sometimes specifically referred to as “central IRS type.” For example, system 100, discussed above, is a central IRS type embodiment. Process flow 200 includes the following steps: S202, S204, S206, S208, S210, S212, S214, S216, S218, S220, S222, S224, S226, S228, S230, S232, S234 and S238. Although much of the process flow of FIG. 3 should be self-explanatory, it is noted that: (i) steps S212 to S234 made a looped process flow “structure” that is performed once for each location on a system-wide basis; and (ii) steps S214 to S232 are a nested loop, nested in the location loop, which nested loop is performed once for each subnet operative at a given location. For example, the subnet nested loop would be performed twice for the first location of FIG. 1 because this particular location includes two subnets (that is, the first and second networks).

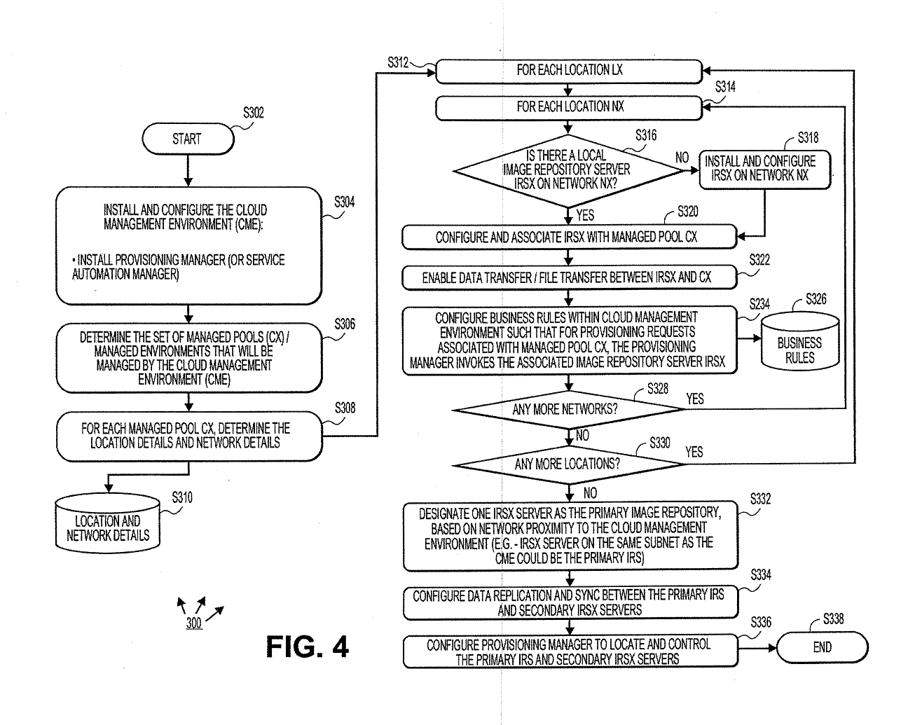

FIG. 4 shows process flow 300 associated with systems where there is not an IRS resident in the CME software itself. These type of embodiments are sometimes specifically referred to as “primary IRS type.” Process flow 300 includes the following steps: S302, S304, S306, S308, S310, S312, S314, S316, S318, S320, S322, S324, S326, S328, S330, S332, S334, S336 and S338. Although much of the process flow of FIG. 4 should be self-explanatory, it is noted that this process flow also includes nested loops for locations and subnets within each location, similar to process flow 200, discussed above.

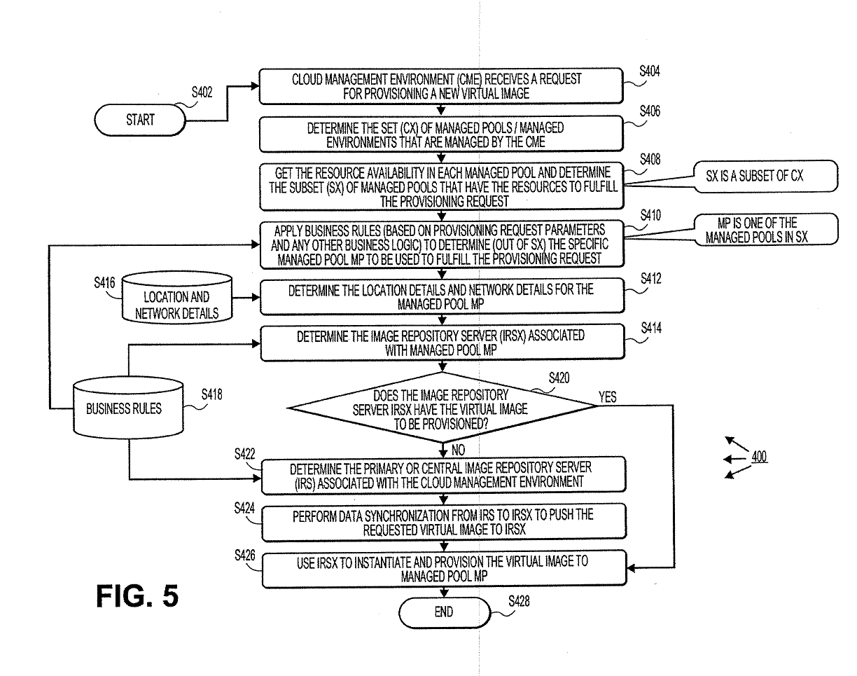

FIG. 5 shows process flow 400 for determining the managed pool and associated IRS to be used for provisioning a given virtual image. Process flow 400 includes the following steps: S402, S404, S406, S408, S410, S412, S414, S416, S418, S420, S422, S424, S426 and S428. Although much of the process flow of FIG. 5 should be self-explanatory, it is noted that this process flow also includes steps to cover the contingency that a requested virtual image, to be provisioned, is not present somehow at the IRS of the subnet of the managed pool to which the virtual image needs to be provisioned. This contingency is handled at steps S422 and S424 of process flow 400.

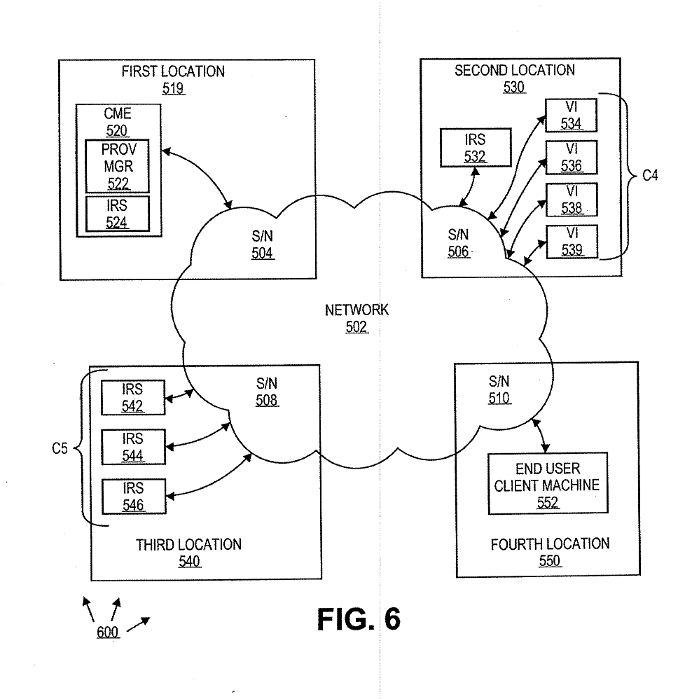

FIG. 6 shows CME system 500 including: network 502; first location 519; second location 530; third location 540; and fourth location 550. Network 502 includes: subnet 504; subnet 506; subnet 508; and subnet 510. First location 519 includes: subnet 504; CME software storage device 520 (which includes provisioning manager module 522 and central IRS 524. The second location includes: subnet 506; IRS 532 and four VIs 534, 536, 538 and 539 (these are in managed pool C4). The third location includes: subnet 508; IRS 542 and two VIs 544, 546 (these are in managed pool C5). Fourth location 550 includes: subnet 510 and end user machine 552. The fourth location does not have a managed pool. If, for some reason, a virtual image was required to be provisioned to machine 552, then this virtual image would be provisioned from central IRS 524. System 500 illustrates the following points: (i) it is possible to have a subnet with an IRS but no managed pool (see the first location 519); and (ii) it is possible to have a subnet with no managed pool and no IRS (see the fourth location 550). However, every location that does have a managed pool will also have its own IRS according to the present invention.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction performance system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction performance system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be performed substantially concurrently, or the blocks may sometimes be performed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

### DEFINITIONS

Any and all published documents mentioned herein shall be considered to be incorporated by reference, in their respective entireties. The following definitions are provided for claim construction purposes:

Present invention: means “at least some embodiments of the present invention,” and the use of the term “present invention” in connection with some feature described herein shall not mean that all claimed embodiments (see DEFINITIONS section) include the referenced feature(s).

Embodiment: a machine, manufacture, system, method, process and/or composition that may (not must) be within the scope of a present or future patent claim of this patent document; often, an “embodiment” will be within the scope of at least some of the originally filed claims and will also end up being within the scope of at least some of the claims as issued (after the claims have been developed through the process of patent prosecution), but this is not necessarily always the case; for example, an “embodiment” might be covered by neither the originally filed claims, nor the claims as issued, despite the description of the “embodiment” as an “embodiment.”

First, second, third, etc. (“ordinals”): Unless otherwise noted, ordinals only serve to distinguish or identify (e.g., various members of a group); the mere use of ordinals shall not be taken to necessarily imply order (for example, time order, space order).

Data communication: any sort of data communication scheme now known or to be developed in the future, including wireless communication, wired communication and communication routes that have wireless and wired portions; data communication is not necessarily limited to: (i) direct data communication; (ii) indirect data communication; and/or (iii) data communication where the format, packetization status, medium, encryption status and/or protocol remains constant over the entire course of the data communication.

Receive/provide/send/input/output: unless otherwise explicitly specified, these words should not be taken to imply: (i) any particular degree of directness with respect to the relationship between their objects and subjects; and/or (ii) absence of intermediate components, actions and/or things interposed between their objects and subjects.

Module/Sub-Module: any set of hardware, firmware and/or software that operatively works to do some kind of function, without regard to whether the module is: (i) in a single local proximity; (ii) distributed over a wide area; (ii) in a single proximity within a larger piece of software code; (iii) located within a single piece of software code; (iv) located in a single storage device, memory or medium; (v) mechanically connected; (vi) electrically connected; and/or (vii) connected in data communication.

Software storage device: any device (or set of devices) capable of storing computer code in a non-transient manner in one or more tangible storage medium(s); “software storage device” does not include any device that stores computer code only as a signal.

base IRS: an IRS that serves as a central IRS (in central IRS type embodiments), or as a primary IRS (in primary IRS type environments); on a related note, a “base IRS determination sub-sub-module” is a module that determines what type of base IRS will be present in the system and, if applicable (as in a primary IRS type environment), with which subnet and/or managed pool the base IRS will be associated.

Unless otherwise explicitly provided in the claim language, steps in method or process claims need only be performed that they happen to be set forth in the claim only to the extent that impossibility or extreme feasibility problems dictate that the recited step order be used. This broad interpretation with respect to step order is to be used regardless of alternative time ordering (that is, time ordering of the claimed steps that is different than the order of recitation in the claim) is particularly mentioned or discussed in this document. Any step order discussed in the above specification, and/or based upon order of step recitation in a claim, shall be considered as required by a method claim only if: (i) the step order is explicitly set forth in the words of the method claim itself; and/or (ii) it would be substantially impossible to perform the method in a different order. Unless otherwise specified in the method claims themselves, steps may be performed simultaneously or in any sort of temporally overlapping manner. Also, when any sort of time ordering is explicitly set forth in a method claim, the time ordering claim language shall not be taken as an implicit limitation on whether claimed steps are immediately consecutive in time, or as an implicit limitation against intervening steps.

What is claimed is:

1. A method of managing a cloud managed environment, the method comprising the following steps:
running CME software comprising a provisioning manager module and stored on a software storage device, with the CME software being in data communication with a plurality of different subnets and with each subnet having a location associated therewith and a set of destination server(s) located at the location of each subnet, with each destination server of each set of server(s) being at least partially under control of the CME software through each destination server's respectively co-located subnet;
establishing and maintaining a base IRS at a first location, under control of the CME software, with the base IRS including a plurality of virtual images, with the plurality of virtual images of the base IRS including all virtual images that may be provisioned by the provisioning manager module to the various destination servers; and
establishing and maintaining a plurality of secondary IRSs so that each subnet of the plurality of different subnets will have co-located with it at least one of the following: (i) the base IRS; or (ii) at least one secondary IRS of the plurality of secondary IRSs;
wherein:
each secondary IRS of the plurality of secondary IRSs includes at least some of the virtual images of the base IRS.

2. The method of claim 1 further comprising the steps of:
provisioning, under control of the provisioning manager module of the CME software, a provisioned virtual image to a first destination server of the plurality of destination servers, with the first destination server being co-located with and in data communication with a first subnet of the plurality of different subnets;
wherein the provisioning step includes the following sub-steps:
determining which destination server is the first destination server;
determining the first subnet based on the identity of the first destination server; and
supplying the provisioned virtual image to the first destination server from a co-located IRS which is: (i) the base IRS; or (ii) a secondary IRS of the plurality of secondary IRSs.

3. The method of claim 2 wherein the co-located IRS is the base IRS.

4. The method of claim 2 wherein the co-located IRS is a secondary IRS.

5. The method of claim 1 wherein the cloud environment is a PaaS type cloud managed environment.

6. The method of claim 1 wherein the cloud environment is a SaaS type cloud managed environment.

7. A computer system, programmed with CME software, the computer system being for use with a cloud managed environment comprising a plurality of different subnets, with each subnet of the plurality of different subnets respectively being in direct and co-local data communication with a managed pool, with each managed pool including a set of destination server(s), the system comprising:
a set of CME computer(s) comprising a CME module in data communication with each subnet of the plurality of different subnets;
wherein:
the CME module comprises a provisioning manager sub-module;
the provisioning manager sub-module comprises:
a pool determination sub-sub-module structured, programmed and/or connected in data communication to determine the plurality of managed pools that are present in the cloud managed environment for virtual image provisioning purposes and to further determine whether each managed pool of the plurality of managed pools has an IRS co-located in direct data communication at the associated subnet of that managed pool;
an IRS creation sub-sub-module structured, programmed and/or connected in data communication to create an co-located IRS for every managed pool that is determined to lack a co-located IRS by the pool determination sub-sub-module; and
an IRS configuration and control sub-sub-module structured, programmed and/or connected in data communication to control the provisioning of virtual images in the cloud managed environment so that when a first virtual image is provisioned to a first destination server on a corresponding co-located subnet, a selected IRS is selected by the IRS configuration and control module to provision the first virtual image to the first destination server so that the selected IRS is on the same subnet as the first destination server.

8. The system of claim 7 wherein the provisioning manager sub-sub-module further comprises a base IRS determination sub-sub-module structured, programmed and/or connected in data communication to designate and control a base IRS from among the IRSs existing in the cloud managed environment.

9. The system of claim 8 wherein the base IRS determination sub-sub-module is further structured, programmed and/or connected in data communication to designate and control a base IRS which is a central IRS that is included in the CME module.

10. The system of claim 8 wherein the base IRS determination sub-sub-module is further structured, programmed and/or connected in data communication to designate and control a base IRS which is a primary IRS that is not included in the CME module.

11. The system of claim 7 wherein the cloud managed environment is a PaaS type cloud managed environment.

12. The system of claim 7 wherein the cloud managed environment is a SaaS type cloud managed environment.

13. A CME software, stored on a software storage device, the CME software being for use with a cloud managed environment comprising a plurality of different subnets, with each subnet of the plurality of different subnets respectively being in direct and co-local data communication with a managed pool, with each managed pool including a set of destination server(s), with the CME software being data communication with each subnet of the plurality of different subnets, the CME software comprising a provisioning manager module which comprises:
a pool determination sub-module structured, programmed and/or connected in data communication to determine the plurality of managed pools that are present in the cloud managed environment for virtual image provisioning purposes and to further determine whether each managed pool of the plurality of managed pools has an IRS co-located in direct data communication at the associated subnet of that managed pool;
an IRS creation sub-module structured, programmed and/or connected in data communication to create an co-located IRS for every managed pool that is determined to lack a co-located IRS by the pool determination sub-module; and
an IRS configuration and control sub-module structured, programmed and/or connected in data communication to control the provisioning of virtual images in the cloud managed environment so that when a first virtual image is provisioned to a first destination server on a corresponding co-located subnet, a selected IRS is selected by the IRS configuration and control module to provision the first virtual image to the first destination server so that the selected IRS is on the same subnet as the first destination server.

14. The CME software of claim 13 wherein the provisioning manager sub-module further comprises a base IRS determination sub-module structured, programmed and/or connected in data communication to designate and control a base IRS from among the IRS s existing in the cloud managed environment.

15. The CME software of claim 14 wherein the base IRS determination sub-module is further structured, programmed and/or connected in data communication to designate and control a base IRS which is a central IRS that is included in the CME software.

16. The CME software of claim 14 wherein the base IRS determination sub-module is further structured, programmed and/or connected in data communication to designate and control a base IRS which is a primary IRS that is not included in the CME software.

17. The CME software of claim 13 wherein the cloud managed environment is a PaaS type cloud managed environment.

18. The CME software of claim 13 wherein the cloud managed environment is a SaaS type cloud managed environment.
